(19) United States
(12) Patent Application Publication
(10) Pub. No.: US 2014/0214746 A1
(43) Pub. Date: Jul. 31, 2014

(54) COMMUNICATION METHOD BETWEEN APPARATUSES, AND COMMUNICATION APPARATUS

(71) Applicant: SENSOLOGY INC., Seoul (KR)

(72) Inventor: Do Gyu SONG, Seoul (KR)

(73) Assignee: SENSOLOGY INC., Seoul (KR)

(21) Appl. No.: 14/035,165

(22) Filed: Sep. 24, 2013

(30) Foreign Application Priority Data
Jan. 29, 2013 (KR) 10-2013-0010067

(51) Int. Cl. G06N 5/02

(52) U.S. Cl. CPC G06N 5/02
USPC 706/46

(57) ABSTRACT

An apparatus for deriving a consultation result communicating with an interlocutor apparatus on the basis of Resource Description Framework (RDF) triples is provided. It includes a user decision making information management unit, an input sentence analysis unit, a consultation unit configured to collect a set of RDF triples concerning the keyword of the input sentence from the RDF triple repository, to send the keyword of the input sentence, a set of RDF triples converted from the input sentence and a set of RDF triples concerning the keyword of the input sentence to an interlocutor apparatus, to create a set of final consultation triples by checking and modifying some consultation triples received from the interlocutor apparatus, and a consultation result output unit configured to create a consultation sentence from the final consultation triples.

### CROSS-REFERENCE TO RELATED APPLICATION

This application claims priority to and the benefit of Korean Patent Application No. 10-2013-0010067 filed in the Korean Intellectual Property Office on Jan. 29, 2013, the entire contents of which are incorporated herein by reference.

### BACKGROUND

(a) Field of the Invention

The present invention generally relates to a method and a system for communication between apparatuses.

(b) Description of the Related Art

People communicate each other in various ways. The most convenient and the most occupying way may be natural language that people use in their everyday life. Natural language is not only easy to use but also deliver content in concrete and detailed way.

When computers deliver concrete and detailed content to other computers and the latter understand precisely the delivered content, the communication between computers on behalf of men becomes possible. Computers communicating each other for users are the important component of artificial intelligence agent, improve convenience of daily life and provide good changes to human lifestyle.

But computers so far aren't able to manipulate fully the flexibility and rich expressiveness of natural language.

Recently some researches concerning the manipulation of meaning of knowledge and information on the basis of Resource Description Framework (RDF) triple that is machine understandable format, are ongoing. RDF triple is an international standard that World Wide Web Consortium takes charge of and is a format representing knowledge and information by triple consisting of a subject, a predicate and an object. Nevertheless, communication between computers using RDF triple is not realized so far.

### SUMMARY

The present invention has been made in an effort to provide a method and system having advantages of communicating between apparatuses.

An exemplary embodiment of the present invention provides an apparatus for deriving a consultation result communicating with an interlocutor apparatus based on Resource Description Framework (RDF) triples, the apparatus including: a user decision making information management unit that converts the information used for decision making into RDF triples, stores the RDF triples in a RDF triple repository and manages the stored RDF triples; an input sentence analysis unit that receives an input sentence entered from user, extracts at least one keyword from the input sentence, and creates RDF triples of the input sentence by converting the input sentence to RDF triples; a consultation unit that extracts RDF triples related to the keyword from the RDF triple repository, sends the keyword, the RDF triples converted from the input sentence and the RDF triples related to the keyword to an interlocutor apparatus, creates final consultation triples by checking and modifying consultation triples received from the interlocutor apparatus; and a consultation result output unit that creates a consultation sentence based on the final consultation triples.

The consultation unit may include a consultation information decision unit that creates consultation information including the keyword, the RDF triples converted from the input sentence and the RDF triples related to the keyword; a consultation information transmission unit that sends the consultation information to the interlocutor apparatus; and a consultation triple creation and check unit that checks whether the received consultation triples mismatch with at least one of the consultation information and decides the received consultation triples as final consultation triples when the received consultation triples do not mismatch with at least one of the consultation information.

The consultation triple creation and check unit may modify the received consultation triples when the received consultation triples mismatch with at least one of the consultation information, and send the modified consultation triples to the interlocutor apparatus.

The consultation result output unit may display information asking whether to accept the consultation sentence to user, outputs the consultation sentence as final consultation result if received acceptance with the consultation sentence, and send the consultation sentence to the interlocutor apparatus.

The consultation result output unit may request the consultation unit to modify the final consultation triples if received non-acceptance with the consultation sentence.

The consultation unit may modify the final consultation triples and send the modified final consultation triples to the interlocutor apparatus.

Another embodiment of the present invention provides an apparatus for deriving a consultation result communicating with an offerer apparatus based on a Resource Description Framework (RDF) triples, the apparatus including: a user decision making information management unit that converts the information used for decision making into RDF triples, stores the RDF triples in a RDF triple repository and manages the stored RDF triples; a consultation unit that receives consultation information from the offerer apparatus, creates consultation triples that satisfy the consultation information comparing the consultation information with the RDF triples stored in the RDF triple repository, sends the consultation triples to the offerer apparatus, checks the consultation triples with a response received from the offerer apparatus and outputs a consultation sentence, wherein the consultation information includes RDF triples related to an input sentence entered in the offerer apparatus.

The consultation information may include the keyword of the input sentence, RDF triples converted from the input sentence and RDF triples related to the keyword, and the RDF triples related to the keyword is the RDF triples that have semantic relation with the keyword, collected from decision making information converted in RDF triple format and stored in the offerer apparatus. The consultation unit may create the consultation triples extracting a set of triples having an identical object from the triples having the same subject and predicate of the consultation information, stored in the RDF triple repository.

The consultation unit may output the consultation sentence as final consultation result in case that the response is a sentence.

The consultation unit may check, in case that the response is not a sentence, whether the RDF triples included in the response mismatch with the RDF triples stored in the RDF triple repository.

The consultation unit may modify the response and sends the modified response to the offerer apparatus in case of mismatch, and send an acceptance message for the response to the offerer apparatus in case that there is no mismatch.

Yet another embodiment of the present invention provides a method for deriving a consultation result based on Resource Description Framework (RDF) triples by first apparatus communicating with second apparatus, the method including: storing information used for decision making into a RDF triple repository; extracting at least one keyword from an input sentence; converting the input sentence to RDF triples; collecting RDF triples related to the keyword from the RDF triple repository; sending consultation information including the keyword, the RDF triples converted from the input sentence and the RDF triples related to the keyword to the second apparatus; receiving consultation triples created based on the consultation information from the second apparatus; checking the consultation triples by comparing the consultation triples with the RDF triples stored in the RDF triple repository and the RDF triples included in the consultation information; and converting the consultation triples to a consultation sentence, in case that there is no mismatch as the checking result.

The checking of the consultation triples may check whether the consultation triples mismatch with all the RDF triples stored in the RDF triple repository and the RDF triples included in the consultation information.

The method may further include: modifying the consultation triples in case that there is at least one mismatch as the checking result; and sending the modified consultation triples to the second apparatus.

The method may further include: displaying information asking whether to accept the consultation sentence to user; if received acceptance with the consultation sentence, sending the consultation sentence to the second apparatus; and outputting the consultation sentence as final consultation result.

The method may further include: if received non-acceptance with the consultation sentence, modifying the consultation triples; and sending the modified consultation triples to the second apparatus.

Yet another embodiment of the present invention provides a method for deriving a consultation result based on Resource Description Framework (RDF) triples by first apparatus communicating with second apparatus, the method including: storing information used for decision making in a RDF triple repository; receiving consultation information from the second apparatus; creating consultation triples by comparing the RDF triples included in the consultation information with all the RDF triples stored in the RDF triple repository; sending the consultation triples to the second apparatus; outputting a consultation sentence made based on a response received from the second apparatus, wherein the consultation information includes RDF triples related to an input sentence entered in the second apparatus.

The consultation information may include the keyword of the input sentence, RDF triples converted from the input sentence and RDF triples related to the keyword, and the RDF triples related to the keyword is the RDF triples that have semantic relation with the keyword, collected from decision making information converted in RDF triple format and stored in the second apparatus.

The outputting of the consultation sentence may include: checking, in case that the response is not a sentence, whether the RDF triples included in the response mismatch with all the RDF triples stored in the RDF triple repository; modifying, in case of mismatch, the response and sending the modified response to the second apparatus; and sending, in case that there is no mismatch, an acceptance message for the response to the second apparatus.

According to an exemplary embodiment of the present invention, the present invention provides a method and an apparatus for a satisfactory consultation result derived from a communication between apparatuses on behalf of human users. The present invention derives some consultation results about date planning, scheduling, agreement, admission, contract, confirmation of mail/phone, document offering and receiving and gift arrangement etc. by communication with other apparatuses. The apparatus carries out consultation with other apparatuses for people, in the result provide convenient lifestyle to people.

### BRIEF DESCRIPTION OF THE DRAWINGS

FIG. 1 is a schematic block diagram of a communication apparatus based on RDF triples according to an exemplary embodiment of the present invention;

FIG. 2 is a schematic block diagram of a consultation unit according to an exemplary embodiment of the present invention;

FIG. 3 is a diagram of a communication apparatus interconnected with an ontology unit according to an exemplary embodiment of the present invention;

FIG. 4 and FIG. 5 are flowcharts illustrating a communication method according to an exemplary embodiment of the present invention.

FIG. 6 is a flowchart illustrating a communication method according to an exemplary embodiment of the present invention.

FIG. 7 is a flowchart illustrating a communication method according to an exemplary embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. And the present invention can be applied to all kinds of languages.

Throughout the specification, unless explicitly described to the contrary, the word “comprise” and variations such as “comprises” or “comprising”, will be understood to imply the inclusion of stated elements but not the exclusion of any other elements.

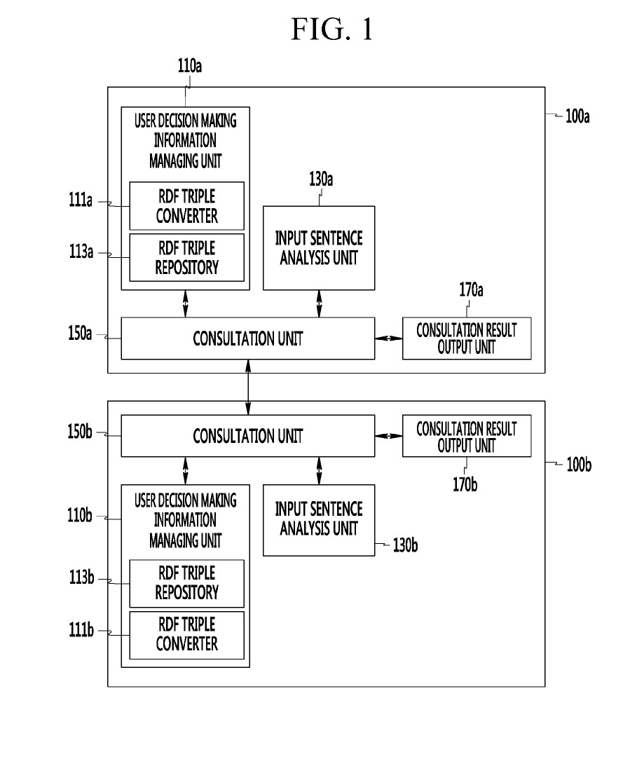

FIG. 1 is a schematic block diagram of a communication apparatus according to an exemplary embodiment of the present invention. The communication apparatus is based on the comparison and conformity of Resource Description Framework (RDF) triples.

Referring to FIG. 1, a communication apparatus includes a user decision making information management unit 110, an input sentence analysis unit 130, a consultation unit 150, and a consultation result output unit 170. The user decision making information management unit 110 includes a RDF triple converter 111 and a RDF triple repository 113.

Here, the communication apparatus of an offerer A is marked with an offerer apparatus 100a, and the communication apparatus of the other B is marked with an interlocutor apparatus 100b. The communication apparatuses 100a and 100b derive consultation result appropriate to the intention of an offerer A and the other B after communicating each other. Hereafter, it's supposed that the offerer apparatus 100a offers consultation to the interlocutor apparatus 100b.

A user decision making information management unit 110a stores information necessary for decision making in a RDF triple repository 113a, as the format appropriate to consultation units 150a, 150b. The user decision making information management unit 110a converts information necessary for decision making to a set of RDF triples and manage the deletion, renewal, sorting and searching of the triples. The information necessary for decision making may be diverse. For example, it may include personal taste information to an item that is preference or non-preference information like Table 1. The format that the consultation unit 150 uses may be RDF triples. Here, RDF triples is a format representing knowledge and information by triple consisting of a subject (resource), a predicate (property) and an object (literal).

TABLE 1

taste

| item | preference | nonpreference |
|---|---|---|
| food | noodle | chinese |
| movie | melodrama | horror/action |
| beverage | coffee | alcohol |
| performance | movie | sports |
| place | cafe | bar |
| leisure | picnic | drinking |
| travel | sea | mountain |

A RDF triple converter 111a converts the information stored in a format like Table 1 in a database into the RDF triples exemplified in Table 2, and stores them in the RDF triple repository 113a. The RDF triple converter 111a converts a record of the table to subject, a field of the table to predicate, and a data of the table to object. And, the RDF triple repository 113a may manage a set of specific subjects as domain.

TABLE 2
domain:taste

| subject | predicate | object |
|---|---|---|
| food | preference | noodle |
| food | nonpreference | chinese |
| movie | preference | melodrama |
| movie | nonpreference | horror/action |
| beverage | preference | coffee |
| beverage | nonpreference | alcohol |
| performance | preference | movie |
| performance | nonpreference | sports |
| place | preference | cafe |
| place | nonpreference | bar |
| leisure | preference | picnic |
| leisure | nonpreference | drinking |
| travel | preference | sea |
| travel | nonpreference | mountain |

An input sentence analysis unit 130a receives an input sentence that a user enters to offering a consultation. The input sentence analysis unit 130a may receive any kind of input forms that can express the user's intention, i.e., sentence, voice, images, signals, etc.

The input sentence analysis unit 130a analyzes the input sentence and extracts at least one keyword from the input sentence. For this, the input sentence analysis unit 130a carries out morphological analysis, morpheme group generation, and sentence component analysis for the input sentence. And the input sentence analysis unit 130a converts the input sentence to a set of RDF triples. For example, the input sentence analysis unit 130a receives an input sentence “I′d like to meet Mr. Obama next Tuesday nearby Central Park”. The input sentence analysis unit 130 at analyzes the input sentence and extracts a keyword “meeting”. And the input sentence analysis unit 130 at converts the input sentence to a set of RDF triples of Table 3.

TABLE 3

| subject | predicate | object |
|---|---|---|
| meeting | time | 20121004;? |
| meeting | partner | Mr. Obama |
| meeting | place | New York Central Park |

The consultation unit 150a derives a consultation result communicating with the interlocutor apparatus 100b by using user decision making information.

The consultation unit 150a sends consultation information to the interlocutor apparatus 100b. The consultation information consists of a keyword, a set of RDF triples of the input sentence and a set of RDF triples concerning the input sentence. The interlocutor apparatus 100b uses the consultation information to check whether it mismatches or not with user decision making information of interlocutor apparatus itself. The set of RDF triples concerning the input sentence consists of RDF triples having a semantic relation with the keyword of input sentence and is extracted from the RDF triples stored in the RDF triple repository 113a. The consultation unit 150a extracts a set of RDF triples having a semantic relation with the keyword of input sentence from the RDF triples stored in the RDF triple repository 113a. For the example above, the consultation unit 150a may extract some RDF triples having a content related with the keyword “meeting” as its domain, for the set of RDF triples having a semantic relation with the keyword of input sentence.

The consultation unit 150b of the interlocutor apparatus 100b compares the RDF triples of the consultation information with the decision making information stored in the RDF triple repository 113b. In other words, the consultation unit 150b extracts a set of objects from the triples having the same subject and predicate of the consultation information, with them of the triples stored in its RDF triple repository 113b. The consultation unit 150b creates a set of consultation triples based on the offerer A's favorite information in consideration of the offerer A's consultation information. Also, the consultation unit 150b creates a set of consultation triples that match all the triples stored in a RDF triple repository 113b. In table 4, for example, the consultation unit 150b creates a set of consultation triples that do not conflict with the meeting 1 and meeting 2 of the table 4.

TABLE 4
domain:schedule

| subject | predicate | object |
|---|---|---|
| meeting1 | place | New York Time Square |
| meeting1 | time | 20121004; 10:00-11:30 |
| meeting2 | place | New York Central Park |
| meeting2 | time | 20121004; 15:00-? |

So, the consultation unit 150b creates, for the example above, a consultation triples like table 5.

TABLE 5

| subject | predicate | object |
|---|---|---|
| meeting | time | 20121004; 13:00 |
| meeting | place | New York Central Park |
| meeting | genre | park |

The consultation unit 150a of the offerer apparatus 100a receives a set of consultation triples like table 5 from the consultation unit 150b of the interlocutor apparatus 100b. In the case that the consultation triples mismatch its decision making information, the consultation unit 150a modifies the consultation triples and sends them to the interlocutor apparatus 100b. On this wise, the consultation units 150a and 150b check and modify the consultation triples until the consultation triples do not conflict with their decision making information stored in their RDF triple repositories.

The consultation units 150a, 150b send an acceptance message to their opponent respectively and confirm the consultation triples as final consultation triples, in the case that the consultation triples do not go against their decision making information stored in their RDF triple repositories.

The consultation result output units 170a, 170b output a consultation sentence converted from the final consultation triples. The consultation result output units 170a, 170b convert a set of final consultation triples, supposing that a word in the position of subject is A, a word in the position of predicate is B and a word in the position of object is C, to a sentence in the form like “the B of A is article C” and recite it. For example of the table 5, the consultation result output units 170a and 170b output a sentence like “the time of meeting is Oct. 4, 2012, the place of meeting is New York Central Park and the genre of meeting is a park”.

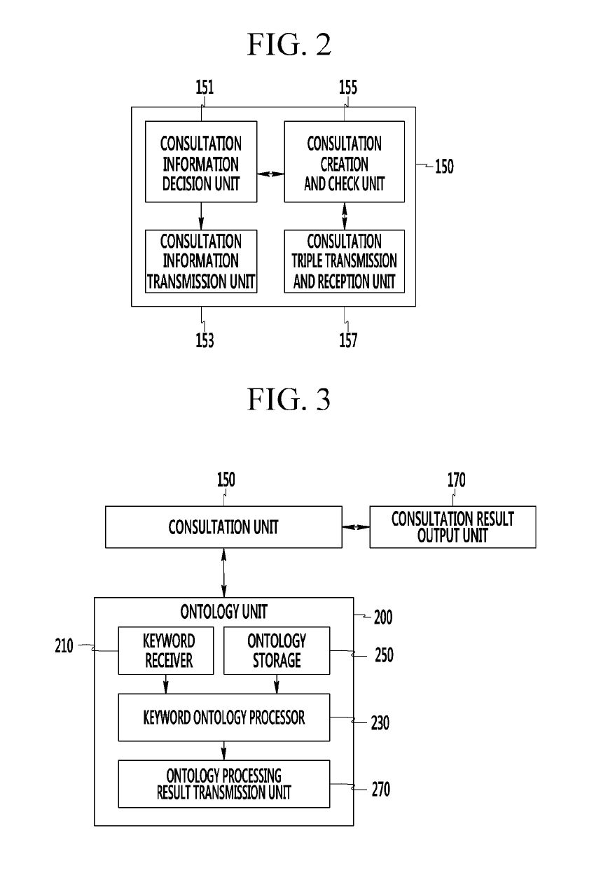

FIG. 2 is a schematic block diagram of a consultation unit according to an exemplary embodiment of the present invention.

Referring to FIG. 2, the consultation unit 150 includes a consultation information decision unit 151, a consultation information transmission unit 153, a consultation triple creation and check unit 155 and a consultation triple transmission and reception unit 157.

The consultation information decision unit 151 begins to act with an input sentence of an offerer A. The consultation information decision unit 151 creates consultation information based on all the information sent from the user decision making information management unit 110 and the input sentence analysis unit 130. The consultation information that includes a keyword of an input sentence, a set of RDF triples converted from the input sentence and a set of RDF triples related to the input sentence, is used to check whether it mismatches or not with a decision making information of an interlocutor apparatus by the latter. The consultation information decision unit 151 extracts a set of RDF triples having a semantic relation with a keyword of input sentence from the RDF triples stored in the RDF triple repository 113.

The consultation information transmission unit 153 sends the consultation information to an interlocutor apparatus of an interlocutor expressed in an input sentence that is, in the example above, Mr. Obama.

The consultation triple creation and check unit 155 creates a set of consultation triples to consult with an interlocutor apparatus and checks a set of consultation triples sent from the interlocutor apparatus. The consultation triple creation and check unit 155 creates a set of consultation triples considering its consultation information and its decision making information stored in the RDF triple repository 113. And the consultation triple creation and check unit 155 sends this set of consultation triples to an interlocutor apparatus. Also, the consultation triple creation and check unit 155 checks whether the consultation triples sent from an interlocutor apparatus mismatch or not with its decision making information triples stored in the RDF triple repository 113. In case of mismatch, the consultation triple creation and check unit 155 modifies the consultation triples and sends the modified consultation triples to an interlocutor apparatus.

The consultation triple creation and check unit 155 derives a consultation result consulting with an interlocutor apparatus until these consultation triples do not go against its decision making information stored in its RDF triple repository.

The consultation triple transmission and reception unit 157 sends the consultation triples created by the consultation triple creation and check unit 155 to an interlocutor apparatus. Or the consultation triple transmission and reception unit 157 receives a set of consultation triples sent from an interlocutor apparatus and sends this to the consultation triple creation and check unit 155.

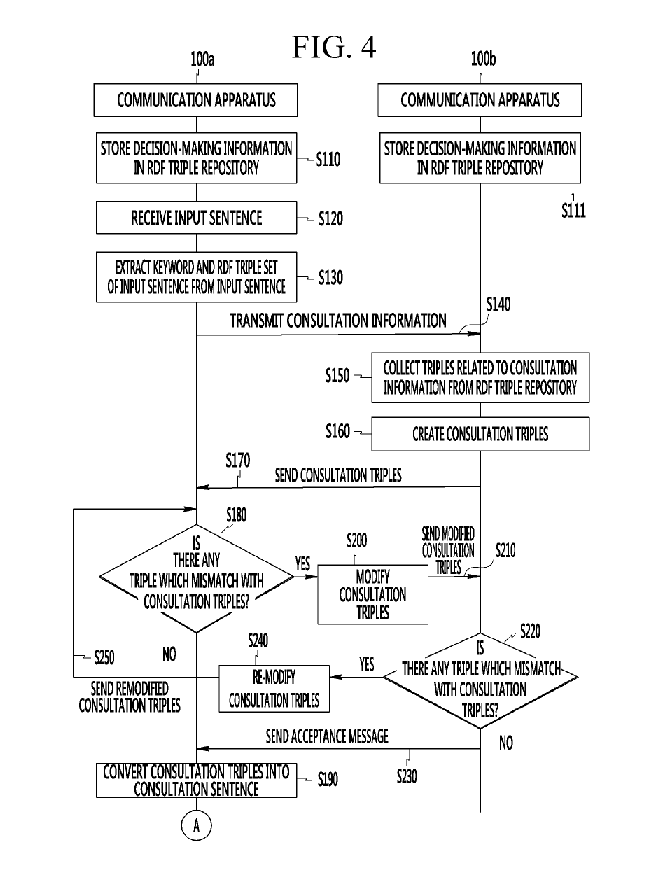

FIG. 3 is a diagram of a communication apparatus interconnected with an ontology unit according to an exemplary embodiment of the present invention.

Referring to FIG. 3, an ontology unit 200 stores some knowledge and information necessary for communication between apparatuses in a machine understandable and formal form that is RDF triple format. The ontology unit 200 includes a keyword receiver 210, a keyword ontology processor 230, an ontology storage 250 and an ontology processing result transmission unit 270.

The consultation unit 150 creates and checks a set of consultation triples in cooperation with the ontology unit 200. The consultation unit 150 extracts some content having a close semantic relation with a consultation information or a set of RDF triples converted from an input sentence using the ontology unit 200, in case that there is no triple identical to the triples converted from an input sentence and those of a consultation information sent from an interlocutor apparatus.

For example, suppose that a user enters an input sentence “arrange a meeting with Mr. Obama on October 4”.

The consultation unit 150 extracts a set of RDF triples belonging to the domains having a semantic relation with a keyword of input sentence that is “meeting in our example above, from the RDF triple repository 113. For example, the consultation unit 150 extracts a set of RDF triples belonging to a domain “movies” like table 6 and those belonging to a domain “restaurants” like table 7.

TABLE 6
domain:movies

| subject | predicate | object |
|---|---|---|
| Lincoln | time | 20121004; 10:00-11:30 |
| Lincoln | place | AMC Empire 25 |
| Iron Man 3 | time | 20121004; 10:00-11:30 |
| Iron Man 3 | place | AMC Aviation 12 |
| Oblivion | time | 20121004; 10:00-11:30 |
| Oblivion | place | AMC Menlo Park 12 |
| New World | time | 20121004; 10:00-11:30 |
| New World | place | AMC Rockaway 16 |

TABLE 7
domain:restaurants

| subject | predicate | object |
|---|---|---|
| Italiano | genre | Italian restaurant |
| Italiano | specialty | spaghetti/pasta |
| Italiano | place | New York Time Square |
| Arirang | genre | Korean restaurant |
| Arirang | specialty | Bibimbap |
| Arirang | place | New York Manhattan |
| Outback | genre | Western restaurant |
| Outback | specialty | Steaks |
| Outback | place | New York Hollywood |

For example of the table 2, having the noodle as user's favorite food, there can be no item identical to noodle as in table 7. In this case, the consultation unit 150 requests an ontology information concerning the keyword “noodle” to the ontology unit 200.

The keyword receiver 210 receives a keyword that is, in our example, “noodle”.

The keyword ontology processor 230 extracts information concerning the keyword “noodle” from the ontology storage 250. The keyword ontology processor 230 extracts a content closely related with the keyword, processing the relationship between classes like standard properties for classes proposed by W3C ‘SubClassOf’, ‘EquivalentClass’ and ‘SuperClassOf’ made on our own. In table 8, for example, the keyword ontology processor 230 comes to extract “pasta” and “spaghetti”, that are in the relation of ‘SubClassOf’ with “noodle”.

TABLE 8

Declaration( Class( :noodle ) )
Declaration( Class( :pasta ) )
Declaration( Class( :spaghetti ) )
SubClassOf( :pasta :noodle )
SubClassOf( :spaghetti :noodle )

The ontology processing result transmission unit 270 sends “pasta” and “spaghetti” to the consultation unit 150.

In our example, the consultation unit 150, even though there is no item having the form “noodle” in the table 7, can choose “spaghetti” specialty restaurant “Italiano” as the meeting place. Now, the consultation unit 150 can create a set of consultation triples as in table 9.

TABLE 9
domain:meeting

| subject | predicate | object |
|---|---|---|
| movie | time | 20121004; 10:00-11:30 |
| movie | place | AMC Empire 25 |
| movie | title | New World |
| food | time | 20121004; 12:00-13:30 |
| food | place | New York Italiano |
| food | genre | spaghetti/pasta |
| promenade | time | 20121004; 13:30-14:30 |
| promenade | place | New York Central Park |
| beverage | time | 20121004; 15:00-16:00 |
| beverage | place | New York PAUL |
| beverage | genre | coffee |

When the set of consultation triples is determined as final consultation result, the consultation result output unit 170 outputs a consultation sentence converted from the set of consultation triples. A consultation sentence can be “the time of movie is Oct. 4, 2012 10:00-11:30, the place of movie is AMC Empire 25, the title of movie is New World, the time of food is Oct. 4, 2012 12:00-13:30, the place of food is the New York Italiano, the genre of food is spaghetti/pasta, the time of promenade is Oct. 4, 2012 13:30-14:30, the place of promenade is New York Central Park, the time of beverage is Oct. 4, 2012 15:00-16:00, the place of beverage is New York PAUL and the genre of beverage is coffee”.

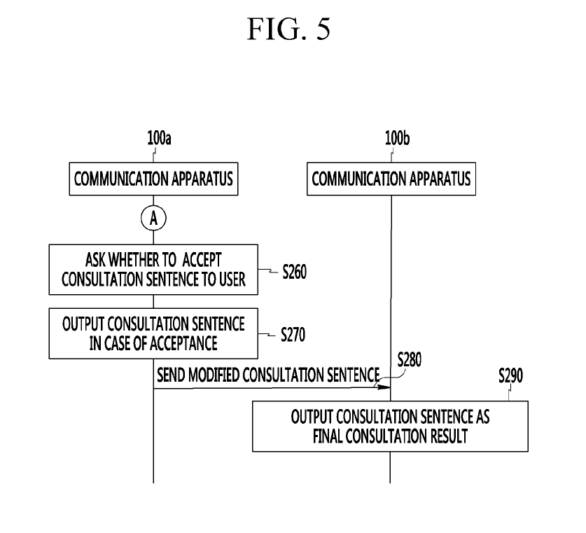

FIG. 4 and FIG. 5 are flowcharts illustrating a communication method according to an exemplary embodiment of the present invention.

Referring to FIG. 4, the communication apparatus 100a and the other communication apparatus 100b, consulting each other, derive a consultation result corresponding to an input sentence.

The communication apparatuses 100a and 100b store some information necessary for decision making in their RDF triple repository respectively (S110, S111). The communication apparatuses 100a and 100b convert this information stored in the form of table to a set of RDF triples.

The communication apparatus 100a receives an input sentence offering a consultation (S120).

The communication apparatus 100a analyzes the input sentence, extracts at least one keyword and converts the input sentence to a set of RDF triples (S130).

The communication apparatus 100a sends a keyword of an input sentence and a consultation information including a set of RDF triples converted from the input sentence to the other communication apparatus 100b (S140). Furthermore, the consultation information may include a set of RDF triples concerning the input sentence extracted from the RDF triple repository 113, and the set of RDF triples concerning the input sentence includes the keyword or a set of RDF triples belonging to the domains having a semantic relation with the keyword of input sentence.

The other communication apparatus 100b collects a set of triples related to the consultation information from the RDF triple repository 113b (S150).

The other communication apparatus 100b creates a set of consultation triples that satisfy the consultation information comparing the collected triples with the consultation information (S160).

The other communication apparatus 100b sends the set of consultation triples to the other communication apparatus 100a (S170).

The communication apparatus 100a compares the RDF triples included in the consultation information with all the RDF triples stored in it and checks whether there are mismatches between two groups of RDF triples (S180). All the RDF triples stored in the communication apparatus 100a consist of all the triples stored in the RDF triple repository 113a, a set of RDF triples converted from an input sentence and the consultation triples.

In case that there is no mismatch, the communication apparatus 100a converts the consultation triples into a consultation sentence (S190).

On the other hand, in case of mismatch, the communication apparatus 100a modifies the consultation triples (S200). That is, the communication apparatus 100a modifies the consultation triples when the received consultation triple conflicts with all the RDF triples stored in the RDF repository 113a.

The communication apparatus 100a sends the modified consultation triples to the other communication apparatus 100b (S210).

The other communication apparatus 100b receives the modified consultation triples and compares them with all the RDF triples stored in it and checks whether there are some mismatches between two groups of RDF triples (S220).

In case that there is no mismatch, the communication apparatus 100b sends an acceptance message to the other communication apparatus 100a (S230). Then, the communication apparatus 100a executes the step S190.

On the other hand, in case of mismatch, the communication apparatus 100b modifies again the consultation triples (S240).

The communication apparatus 100b sends the remodified consultation triples to the communication apparatus 100a (S250). In this case, the communication apparatus 100a executes the step S180.

Referring to FIG. 5, after the step S190, the communication apparatus 100a asks whether to accept the consultation sentence to user (S260).

In case of acceptance, the communication apparatus 100a outputs the consultation sentence as final consultation result (S270). In case of non-acceptance, the communication apparatus 100a moves to the step S200 and modifies the consultation triples.

And the communication apparatus 100a sends the modified consultation triples to the other communication apparatus 100b (S280).

The communication apparatus 100b receives the information from the communication apparatus 100a and checks whether this information is a sentence or not. In case that this is a sentence, the communication apparatus 100b outputs this sentence as final consultation result (S290).

In the other case, the communication apparatus 100b checks whether the RDF triples included in the information mismatch or not with all the RDF triples stored in it. In case that there is no mismatch, the communication apparatus 100b accepts the information. In the other case, the communication apparatus 100b modifies the information.

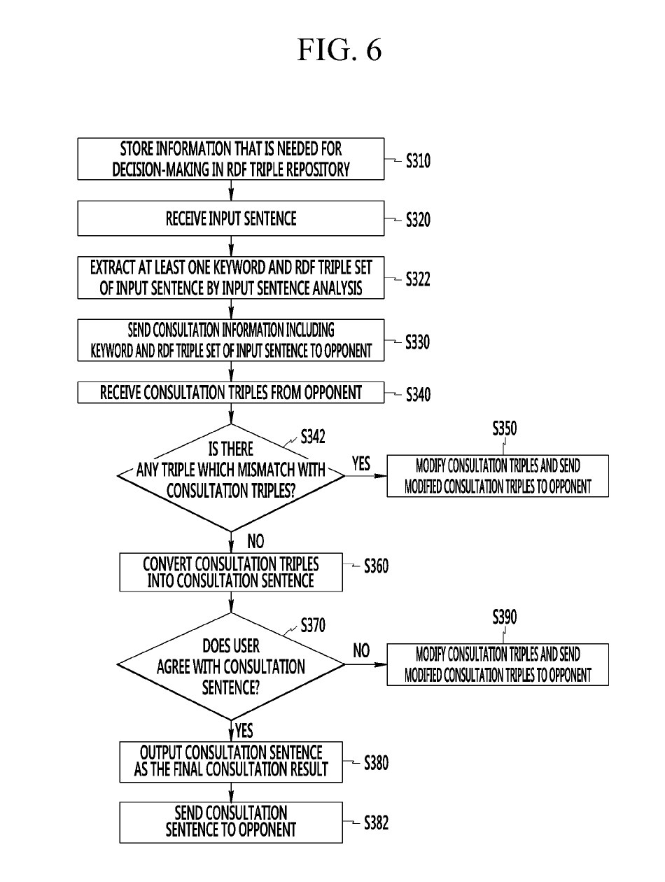

FIG. 6 is a flowchart illustrating a communication method according to an exemplary embodiment of the present invention.

Referring to FIG. 6, the communication apparatus 100a, i.e., the offerer apparatus 100a stores some information that is needed for decision making in the RDF triple repository 113a (S310).

The communication apparatus 100a receives an input sentence (S320).

The communication apparatus 100a analyzes the input sentence, extracts at least one keyword and converts the input sentence to a set of RDF triples (S322).

The communication apparatus 100a sends a consultation information including the keyword of the input sentence and a set of RDF triples converted from the input sentence to the opponent, the interlocutor apparatus 100b (S330).

The communication apparatus 100a receives consultation triples from the interlocutor apparatus 100b (S340).

The communication apparatus 100a compares the consultation triples with all the RDF triples stored in it and checks whether there are mismatches or conflicts between two groups of RDF triples (S342). All the RDF triples stored in the communication apparatus 100a consist of all the triples stored in the RDF triple repository 113a, a set of RDF triples converted from an input sentence and the consultation triples.

In case of mismatch, the communication apparatus 100a modifies the consultation triples and sends them to the interlocutor apparatus 100b (S350).

On the other hand, in case that there is no mismatch, the communication apparatus 100a converts the consultation triples into a consultation sentence (S360).

The communication apparatus 100a asks whether to agree with the consultation sentence to user (S370).

In case of acceptance, the communication apparatus 100a outputs the consultation sentence as final consultation result (S380). Also, the communication apparatus 100a sends the consultation sentence to the interlocutor apparatus 100b (S382).

In the other case, the communication apparatus 100a modifies the consultation triples and sends these modified consultation triples to the interlocutor apparatus 100b (S390).

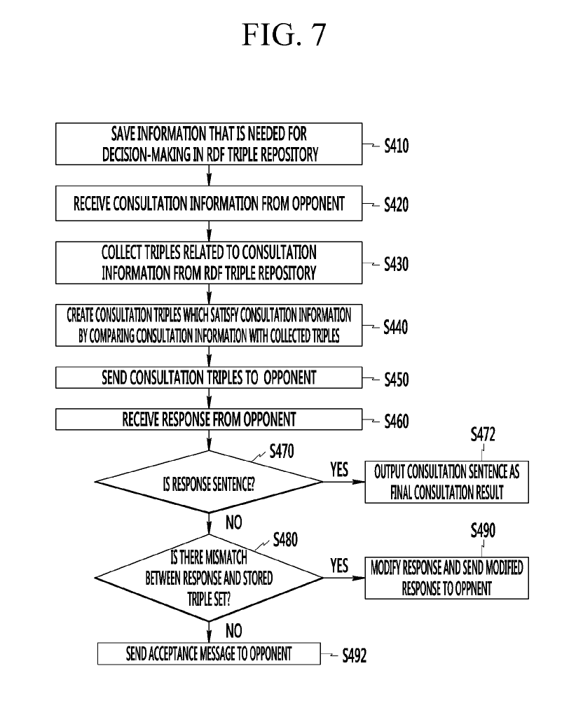

FIG. 7 is a flowchart illustrating a communication method according to an exemplary embodiment of the present invention.

Referring to FIG. 7, the communication apparatus 100b, i.e., the interlocutor apparatus 100b stores information that is needed for decision making in its RDF triple repository (S410).

The communication apparatus 100b receives consultation information from the opponent, the offerer apparatus 100a (S420). The consultation information consists of a keyword of an input sentence, a set of RDF triples converted from the input sentence and a set of RDF triples concerning the input sentence.

The communication apparatus 100b collects a set of RDF triples related to the consultation information from its RDF triple repository 113b (S430).

The communication apparatus 100b creates a set of consultation triples that satisfy the consultation information comparing collected triples with the consultation information (S440).

The communication apparatus 100b sends the set of consultation triples to the offerer apparatus 100a (S450).

The communication apparatus 100b receives a response from the offerer apparatus 100a (S460).

The communication apparatus 100b checks whether this response is a sentence or not (S470).

In case that this is a sentence, the communication apparatus 100b outputs this sentence as final consultation result (S472).

In the other case, the communication apparatus 100b checks whether the RDF triples included in the response mismatch or conflict with all the RDF triples stored in it (S480). Here, the response that is not a sentence consists only of the modified consultation triples.

In case of mismatch, the communication apparatus 100b modifies the response and sends the modified response to the offerer apparatus 100a (S490).

On the other hand, in case that there is no mismatch, the communication apparatus 100b sends an acceptance message to the offerer apparatus 100a (S492).

As described above, according to the embodiment of the present invention, the communication method between apparatuses based on the systematic processing where the communication apparatus 100a sends some information for a consultation and the other communication apparatus 100b creates some consultation triples is provided. But it's also possible that the communication apparatus 100a creates some consultation triples, and the communication apparatus 100b accepts or modifies them.

An exemplary embodiment of the present invention provides a method and an apparatus for a satisfactory consultation result derived from a communication between apparatuses on behalf of human users. The main idea of the present invention is to derive some consultation results about date planning, scheduling, agreement, admission, contract, confirmation of mail/phone, document offering and receiving and gift arrangement etc. by communication with other apparatuses. The communication apparatuses carry out a consultation with other apparatuses for people, in the result, provide convenient lifestyle to people.

The embodiments of the present invention are not only implemented through the method and apparatus, but may be implemented through a program for realizing a function corresponding to a construction according to an embodiment of the present invention or a recording medium on which the program is recorded.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

And the present invention can be applied to all kinds of languages.

What is claimed is:

1. An apparatus for deriving a consultation result communicating with an interlocutor apparatus based on Resource Description Framework (RDF) triples, the apparatus comprising:
a user decision making information management unit that converts the information used for decision making into RDF triples, stores the RDF triples in a RDF triple repository and manages the stored RDF triples;
an input sentence analysis unit that receives an input sentence entered from user, extracts at least one keyword from the input sentence, and creates RDF triples of the input sentence by converting the input sentence to RDF triples;
a consultation unit that extracts RDF triples related to the keyword from the RDF triple repository, sends the keyword, the RDF triples converted from the input sentence and the RDF triples related to the keyword to an interlocutor apparatus, creates final consultation triples by checking and modifying consultation triples received from the interlocutor apparatus; and
a consultation result output unit that creates a consultation sentence based on the final consultation triples.

2. The apparatus of claim 1, wherein the consultation unit comprises:
a consultation information decision unit that creates consultation information including the keyword, the RDF triples converted from the input sentence and the RDF triples related to the keyword;
a consultation information transmission unit that sends the consultation information to the interlocutor apparatus; and
a consultation triple creation and check unit that checks whether the received consultation triples mismatch with at least one of the consultation information and decides the received consultation triples as final consultation triples when the received consultation triples do not mismatch with at least one of the consultation information.

3. The apparatus of claim 1, wherein the consultation triple creation and check unit modifies the received consultation triples when the received consultation triples mismatch with at least one of the consultation information, and sends the modified consultation triples to the interlocutor apparatus.

4. The apparatus of claim 1, wherein the consultation result output unit displays information asking whether to accept the consultation sentence to user, outputs the consultation sentence as final consultation result if received acceptance with the consultation sentence, and sends the consultation sentence to the interlocutor apparatus.

5. The apparatus of claim 4, wherein the consultation result output unit requests the consultation unit to modify the final consultation triples if received non-acceptance with the consultation sentence.

6. The apparatus of claim 5, wherein the consultation unit modifies the final consultation triples and sends the modified final consultation triples to the interlocutor apparatus.

7. An apparatus for deriving a consultation result communicating with an offerer apparatus based on a Resource Description Framework (RDF) triples, the apparatus comprising:
a user decision making information management unit that converts the information used for decision making into RDF triples, stores the RDF triples in a RDF triple repository and manages the stored RDF triples; and
a consultation unit that receives consultation information from the offerer apparatus, creates consultation triples that satisfy the consultation information comparing the consultation information with the RDF triples stored in the RDF triple repository, sends the consultation triples to the offerer apparatus, checks the consultation triples with a response received from the offerer apparatus and outputs a consultation sentence,
wherein the consultation information includes RDF triples related to an input sentence entered in the offerer apparatus.

8. The apparatus of claim 7, wherein
the consultation information includes the keyword of the input sentence, RDF triples converted from the input sentence and RDF triples related to the keyword, and
the RDF triples related to the keyword is the RDF triples that have semantic relation with the keyword, collected from decision making information converted in RDF triple format and stored in the offerer apparatus.

9. The apparatus of claim 7, wherein the consultation unit creates the consultation triples extracting a set of triples having an identical object from the triples having the same subject and predicate of the consultation information, stored in the RDF triple repository.

10. The apparatus of claim 7, wherein the consultation unit outputs the consultation sentence as final consultation result in case that the response is a sentence.

11. The apparatus of claim 7, wherein the consultation unit checks, in case that the response is not a sentence, whether the RDF triples included in the response mismatch with the RDF triples stored in the RDF triple repository.

12. The apparatus of claim 11, wherein the consultation unit modifies the response and sends the modified response to the offerer apparatus in case of mismatch, and sends an acceptance message for the response to the offerer apparatus in case that there is no mismatch.

13. A method for deriving a consultation result based on Resource Description Framework (RDF) triples by first apparatus communicating with second apparatus, the method comprising:
storing information used for decision making into a RDF triple repository;
extracting at least one keyword from an input sentence;
converting the input sentence to RDF triples;
collecting RDF triples related to the keyword from the RDF triple repository;
sending consultation information including the keyword, the RDF triples converted from the input sentence and the RDF triples related to the keyword to the second apparatus;
receiving consultation triples created based on the consultation information from the second apparatus;
checking the consultation triples by comparing the consultation triples with the RDF triples stored in the RDF triple repository and the RDF triples included in the consultation information; and
converting the consultation triples to a consultation sentence, in case that there is no mismatch as the checking result.

14. The method of claim 13, wherein the checking of the consultation triples checks whether the consultation triples mismatch with all the RDF triples stored in the RDF triple repository and the RDF triples included in the consultation information.

15. The method of claim 13, further comprising:
modifying the consultation triples in case that there is at least one mismatch as the checking result; and
sending the modified consultation triples to the second apparatus.

16. The method of claim 13, further comprising:
displaying information asking whether to accept the consultation sentence to user;
if received acceptance with the consultation sentence, sending the consultation sentence to the second apparatus; and
outputting the consultation sentence as final consultation result.

17. The method of claim 13, further comprising:
if received non-acceptance with the consultation sentence, modifying the consultation triples; and
sending the modified consultation triples to the second apparatus.

18. A method for deriving a consultation result based on Resource Description Framework (RDF) triples by first apparatus communicating with second apparatus, the method comprising:
storing information used for decision making in a RDF triple repository;
receiving consultation information from the second apparatus;
creating consultation triples by comparing the RDF triples included in the consultation information with all the RDF triples stored in the RDF triple repository;
sending the consultation triples to the second apparatus; and
outputting a consultation sentence made based on a response received from the second apparatus,
wherein the consultation information includes RDF triples related to an input sentence entered in the second apparatus.

19. The method of claim 18, wherein
the consultation information includes the keyword of the input sentence, RDF triples converted from the input sentence and RDF triples related to the keyword, and
the RDF triples related to the keyword is the RDF triples that have semantic relation with the keyword, collected from decision making information converted in RDF triple format and stored in the second apparatus.

20. The method of claim 18, wherein the outputting of the consultation sentence comprising:
checking, in case that the response is not a sentence, whether the RDF triples included in the response mismatch with all the RDF triples stored in the RDF triple repository;
modifying, in case of mismatch, the response and sending the modified response to the second apparatus; and
sending, in case that there is no mismatch, an acceptance message for the response to the second apparatus.
